(19) United States
(12) Patent Application Publication
(10) Pub. No.: US 2012/0115438 A1
(43) Pub. Date: May 10, 2012

(54) Use of mobile phone lock screen to display vital information

(76) Inventor: Samuel Okechukwu Umealu, Melbourne (AU)

(21) Appl. No.: 12/941,081

(22) Filed: Nov. 7, 2010

(51) Int. Cl. H04M 1/66; H04M 3/42

(52) U.S. Cl. 455/411; 455/414.1

(57) ABSTRACT

Superimposition of information on image files is not by itself novel. The originality of this invention lies on superimposing information on an image file by using any of the methods described in Section 8 (Detailed Description of the Invention) and then using the resulting image in the manner described in Section 6 (Brief Summary of the Invention) to provide a solution to the problems described in Section 5 (Background of Invention) and to add value to the use of mobile phone as listed in Section 6 (Brief Summary of the Invention).

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

One method of preventing unauthorised access to information contained in a mobile phone handset is to use a password-protected lock screen. The use of password-protected lock screen has become a standard feature of mobile phones. When a lock screen is password-protected, a potential user is firstly challenged to provide the correct password, prior to using the phone. The password, so provided is used for access verification users through authentication, prior to granting them access to the functionality and inherent data of the mobile. Therefore, password-protected screen locking prevents un-authorised use of mobile phones.

When a mobile phone is lost and found, the finder must firstly retrieve information inherent in the phone in order to identify the owner of the handset and hence where and how to return it. Gaining access to this information would not possible, if the mobile phone handset is password-protected, as the finder is unlikely to know the password. This difficulty acts as disincentive for the use of the password-protected lock screen feature of mobile phone handsets.

Provision of the terms and conditions by an organisation and acceptance of these terms and conditions by users normally constitutes the legal or policy requirement before misuse of a corporate asset can be alleged. Due to the difficulty described in paragraph [0002], the use of the password-protected lock screen feature of mobile phone handsets is not popular. Therefore, many organisations are currently not inclined to use the screen of mobile phone handset in displaying the terms and conditions for the use of this asset. Therefore organisations miss the opportunity to utilise the lock screen in protecting one of their most important category of assets (mobile phone handsets) from misuse.

### BRIEF SUMMARY OF THE INVENTION

This invention provides viable solution to problems described in the “Background of the Invention” section. It superimposes vital information on an image file which is then used as lock screen on a typical mobile phone handset, as illustrated by the diagrams in the “Drawing” section. The invention delivers the following values:
1. Provide vital information regarding where and how to return a “lost and found” mobile phone handset, for the benefit of others who are unable to gain access to this information because the handset is password protected. This information may include one or more of the following:
   i. Name of an individual or corporate entity
   ii. An address of where to return the handset
   iii. Phone number to call in the event that the handset is lost and found
   iv. Reward
   v. Any other piece(s) that may be considered vital for the purpose of returning a “lost and found” mobile phone handset.
2. Provides a platform or medium for an individual or organisation to alert others to the fact that keeping and/or any un-authorised use of the handset is an offence for which the offender may be legally prosecuted.
3. Provides a platform or medium for an individual or organisation to alert others to the fact that illegal use of the handset constitutes legal offence or a breach of corporate policy.
4. Provides a platform or medium for an individual or organisation to alert others as to what may constitute an illegal use of the handset.
5. Provides a platform or medium for an individual or organisation to alert potential users as to term and conditions for the use of mobile phone handset.
6. Provides information on rewards should the handset be returned which may act as an incentive for a “lost and found” handset to be returned to the owner.
7. Provides a disincentive to keep a “lost and found” handset, as the finder may not be able to use it because it is password-protected, whereas they can return it to the owner by using the information displayed on the lock screen, and possibly receive a reward.

### BRIEF DESCRIPTION OF THE SEVERAL VIEWS OF THE DRAWINGS

This invention is illustrated more clearly in photographs rather than hand drawings. Boxes are then drawn on these photographs to further improve elaboration. It contains two diagrams depicted as FIGS. 1 and 2, the “Drawing” section.

FIG. 1 illustrates the result of superimposing an image file with useful information by any of the methods listed in the “Detailed Description of the Invention” section. The box labeled “A”, contains a sample of useful information that may be superimposed on a typical image file. An image file of one's choice can be used for this purpose.

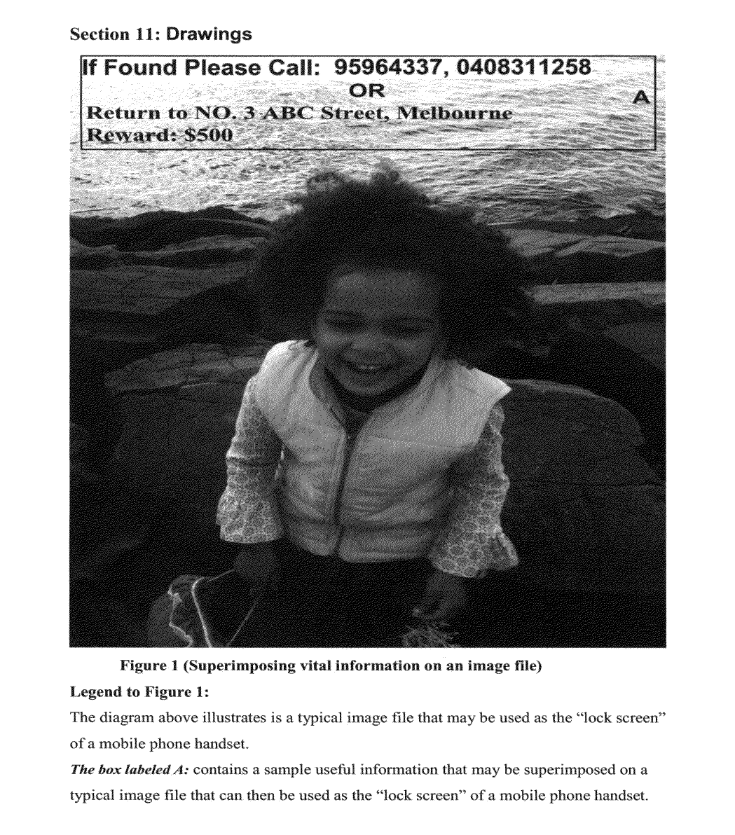

FIG. 2 illustrates the use of the image file typically resulting from the paragraph [0002], as lock screen on a mobile phone handset. Apple® iPhone®) is used in this diagram as an example of a mobile phone handset. The box labeled “A”, contains an sample useful information that may be displayed on a locked screen of a password-protected mobile phone handset. The box labeled “B”, is the portion of the screen on Apple® iPhone®) where users are currently prompted to provide their password. The box labeled “C”, is the rest of Apple® iPhone® screen.

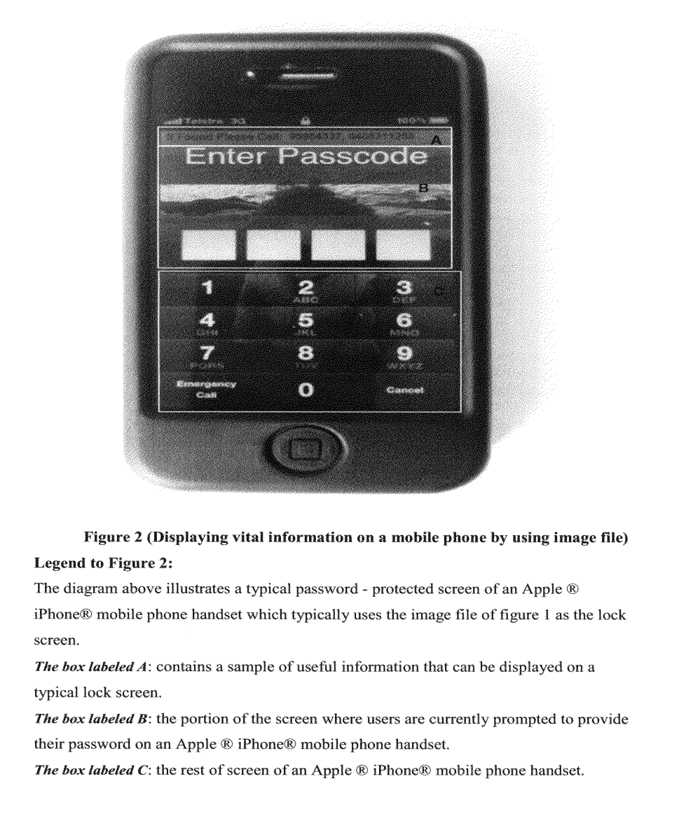

### DETAILED DESCRIPTION OF THE INVENTION

This invention is about using the image file of one's choice to display useful information, as listed in “Brief Summary of the Invention” section, on any part of the lock screen of a mobile phone handset. This is for the benefit of others who are unable to access such information from the mobile handset because the handset is password-protected by the owner.

This is achieved by superimposing the required information on an image file which is then used as the a lock screen of a mobile phone handset. Superimposition of the information on an image file for this purpose may include but not limited to the following methods:
1. Importing the original image file into Microsoft® Paint and/or any other similar software and then putting the required information on the image.
2. Utilizing a software or process that prompts user to enter the required information on the original image file which is intended to be use as lock screen. This information may be displayed on the lock screen as provided. Alternatively, information displayed on the lock screen may be a derivative from or a translation of some other piece(s) of information.
3. Utilizing a software or process that prompts user to enter the required information on the original image file which is already in use as a lock screen. This information may be displayed on the lock screen as provided. Alternatively, information displayed on the lock screen may be a derivative from or a translation of some other piece(s) of information.
4. Using a software or process which utilises information provided on an online screen. This information may be displayed on the lock screen as originally provided. Alternatively, information displayed on the lock screen may be a derivative from or a translation of some other piece(s) of information.
5. Using a software or process to read the contents of a data file or database table to retrieve information which is then displayed on the lock screen. This data may be displayed on the lock screen as retrieved from a data file or database table. Alternatively, information displayed on the lock screen may be a derivative from or a translation of the original data as contained in data file or database table.
6. Using a software or process which utilises voice input to form visual data which is then displayed on the lock screen.

1. Superimposition of information on an image file by any or combination of methods listed in section A below and to then use the resulting file (image plus superimposed information) as the lock screen of mobile phone handset for any of the purposes listed in section B below.
Section A
I. Import the original image file into Microsoft® Paint and any other similar software and then putting the required information on the image.
II. Utilize a software or process that prompts user to enter the required information on the original image file which is intended to be use as lock screen. This information may be displayed on the lock screen as provided. Alternatively, information displayed on the lock screen may be a derivative from or a translation of some other piece(s) of information.
III. Utilize a software or process that prompts user to enter the required information on the original image file which is already in use as a lock screen. This information may be displayed on the lock screen as provided. Alternatively, information displayed on the lock screen may be a derivative from or a translation of some other piece(s) of information.
IV. Use a software or process which utilises information provided on an online screen. This information may be displayed on the lock screen as originally provided. Alternatively, information displayed on the lock screen may be a derivative from or a translation of some other piece(s) of information.
V. Use a software or process to read contents of a data file or database table to retrieve data which is then used to form the information to be displayed on the lock screen. This data may be displayed on the lock screen as retrieved from a data file or database table. Alternatively, information displayed on the lock screen may be a derivative from or a translation of the original data as contained in data file or database table.
VI. Use a software or process which utilises voice input to form visual data which is then displayed on the lock screen.
Section B
I. Provide information on where and how to return a “lost and found” mobile handset, including but not limited to one or more of the following:
1. Name of an individual or corporate entity
2. An address of where to return the handset
3. Phone number to call in the event that the handset is lost and found
4. Reward
5. Any other piece(s) that may be considered vital for the purpose of returning a “lost and found” mobile phone handset.
II. Provide a platform or medium for an individual or organisation to alert others to the fact that keeping and/or any un-authorised use of a “lost and found” mobile phone handset is an offence for which the offender may be legally prosecuted.
III. Provide a platform or medium for an individual or organisation to alert others to the fact that illegal use of a mobile phone handset constitutes legal offence or a breach of corporate policy.
IV. Provide a platform or medium for an individual or organisation to alert others as to what may constitute an illegal use of a mobile phone handset.
V. Provide a platform or medium for an individual or organisation to alert potential users as to term and conditions for the use of a mobile phone handset.
VI. Provide information on rewards should the handset be returned which may act as an incentive for a “lost and found” mobile phone handset to be returned to the owner.
VII. Provide a disincentive to keep a “lost and found” mobile phone handset by the finder.
